(19) United States
(12) Patent Application Publication
(10) Pub. No.: US 2020/0275544 A1
(43) Pub. Date: Aug. 27, 2020

(54) ILLUMINATION CONTROL SYSTEMS AND METHODS

(71) Applicant: METIS IP (SUZHOU) LLC, Suzhou (CN)

(72) Inventors: Shan GUAN, Fremont, CA (US); Qinggang HE, Shanghai (CN)

(73) Assignee: METIS IP (SUZHOU) LLC, Suzhou (CN)

(21) Appl. No.: 16/643,894

(22) PCT Filed: Sep. 4, 2017
(86) PCT No.: PCT/CN2017/100433

§ 371 Date: Mar. 3, 2020

(51) Int. Cl. H05B 47/18; H05B 45/14; H05B 45/37; G01J 1/32

(52) U.S. Cl. CPC H05B 47/18; G01J 1/32; H05B 45/37; H05B 45/14

(57) ABSTRACT

The present disclosure provides a method including providing a dimming circuit applied with an alternating current voltage and an illumination device connected to the dimming circuit; obtaining related data of the illumination device within at least one alternating current period; generating a processing result by processing the related data; and determining a type of the illumination device based on the processing result.

### TECHNICAL FIELD

The present disclosure relates to illumination control systems and methods, and in particular, relates to illumination control systems and methods for determining a type of an illumination device.

### BACKGROUND

With the development of dimming control of illumination systems, illumination control systems are more and more popular in a plurality of occasions. Current illumination device may include a dimmable illumination type and a non-dimmable illumination type. Users often need to consult relevant product manuals when they need to distinguish a type of an illumination device, which lacks convenience. Therefore, more convenient and more user-friendly illumination control systems are needed.

### SUMMARY

According to an aspect of the present disclosure, there is a system provided. The system may include a dimming circuit applied with an alternating current voltage, and a processor configured to obtain related data of an illumination device connected to the dimming circuit within at least one alternating current period, generate a processing result by processing the related data, and determine a type of the illumination device based on the processing result.

According to one aspect of the present disclosure, the dimming circuit may include a silicon controlled dimming circuit using phase control.

According to one aspect of the present disclosure, the related data of the illumination device within the at least one alternating current period may include at least one of voltage data or current data.

According to one aspect of the present disclosure, the related data of the illumination device within the at least one alternating current period may include voltage values across the illumination device during a period before a zero crossing point of the dimming circuit in an alternating current period.

According to an aspect of the present disclosure, the processor may further be configured to: determine whether the voltage values across the illumination device are within a first interval; and in response to a determination that the voltage values are within the first interval, determine that the illumination device is a dimmable illumination device.

According to an aspect of the present disclosure, the processor may further be configured to: determine whether the voltage values across the illumination device are within a second interval; and in response to a determination that the voltage values are withs in the second interval, determine that the illumination device is a non-dimmable illumination device.

According to one aspect of the present disclosure, the related data of the illumination device within the at least one alternating current period may include current values of the illumination device during a period before the zero crossing point of the dimming circuit in an alternating current period.

According to an aspect of the present disclosure, the processor may further be configured to: determine whether the current values of the illumination device are within a third interval; and in response to a determination that the voltage values are with in the third interval, determine that the illumination device is a dimmable illumination device.

According to an aspect of the present disclosure, the processor may further be configured to: determine whether the current values of the illumination device are within a fourth interval; and in response to a determination that the voltage values are within the fourth interval, determine that the illumination device is a non-dimmable illumination device

According to one aspect of the present disclosure, the related data of the illumination device within the at least one alternating current period may include current amplitude values in at least two adjacent alternating current periods.

According to an aspect of the present disclosure, the processor may further be configured to: determine whether the current amplitude values of the illumination device are zero; and in response to a determination that the current amplitude values are zero, determine that the illumination device is a non-dimmable illumination device.

According to an aspect of the present disclosure, the processor may further be configured to: determine whether the current amplitude values of the illumination device are within a fifth interval; and in response to a determination that the current amplitude values are within the fifth interval, determine that the illumination device is a dimmable illumination device.

According to one aspect of the present disclosure, the type of illumination device may include at least one of a dimmable illumination device or a non-dimmable illumination device.

According to one aspect of the present disclosure, a method is provided, which may include providing a dimming circuit applied with an alternating current voltage and an illumination device connected to the dimming circuit; obtaining related data of the illumination device in at least one alternating current period; generating a processing result by processing the related data; and determining a type of the illumination device based on the processing result.

Some of the additional features of the present disclosure may be explained in the following description. Some of the additional characteristics of the present disclosure will be apparent to those skilled in the art from a review of the following description and the corresponding drawings, or an understanding of the production or operation of the embodiments. The features of this disclosure may be realized and achieved through the practice or use of methods, means, and combinations of various aspects of the specific embodiments described below.

### BRIEF DESCRIPTION OF THE DRAWINGS

In order to illustrate the technical solutions related to the embodiments of the present disclosure, a brief introduction of the drawings referred to the description of the embodiments is provided below. Obviously, drawings described below are only some examples or embodiments of the present disclosure. Those having ordinary skills in the art, without further creative efforts, may apply the present disclosure to other similar scenarios according to these drawings. Unless stated otherwise or obvious from the context, the same reference numeral in the drawings refers to the same structure and operation.

FIG. 1 is a schematic diagram illustrating an application scenario of an illumination control system according to some embodiments of the present disclosure;

FIG. 2 is a block diagram illustrating an exemplary illumination control system according to some embodiments of the present disclosure;

FIG. 3 is a schematic diagram illustrating an exemplary application circuit of an illumination control system according to some embodiments of the present disclosure;

FIG. 4 is a schematic diagram illustrating an exemplary waveform of a leading-edge phase-cut dimming control according to some embodiments of the present disclosure;

FIG. 5 is a schematic diagram illustrating an exemplary amplitude-phase of voltage-current of a dimmable illumination device according to some embodiments of the present disclosure;

FIG. 6 is a schematic diagram illustrating an exemplary amplitude-phase of voltage-current of a dimmable illumination device according to some embodiments of the present disclosure;

FIG. 7 is a schematic diagram illustrating an exemplary amplitude-phase of voltage-current of a non-dimmable illumination device according to some embodiments of the present disclosure;

FIG. 8 is a flowchart illustrating an exemplary method for determining a type of an illumination device according to some embodiments of the present disclosure;

FIG. 9 is a flowchart illustrating an exemplary method for determining a type ofan illumination device according to some embodiments of the present disclosure;

FIG. 10 is a flowchart illustrating an exemplary method for determining a type of an illumination device according to some embodiments of the present disclosure;

FIG. 11 is a schematic diagram illustrating an exemplary current waveform of an illumination device according to some embodiments of the present disclosure; and

FIG. 12 is a flowchart illustrating an exemplary method for determining a type of an illumination device according to some embodiments of the present disclosure.

### DETAILED DESCRIPTION

As used in the disclosure and the appended claims, the singular forms “a,” “an,” and “the” include plural referents unless the content clearly dictates otherwise. In general, the terms “comprise” and “include” merely prompt to include steps and elements that have been clearly identified, and these steps and elements do not constitute an exclusive listing. The methods or devices may also include other steps or elements. The term “based on” is “based at least in part on.” The term “one embodiment” means “at least one embodiment;” the term “another embodiment” means “at least one other embodiment.” Relevant definitions of other terms will be given in the description below.

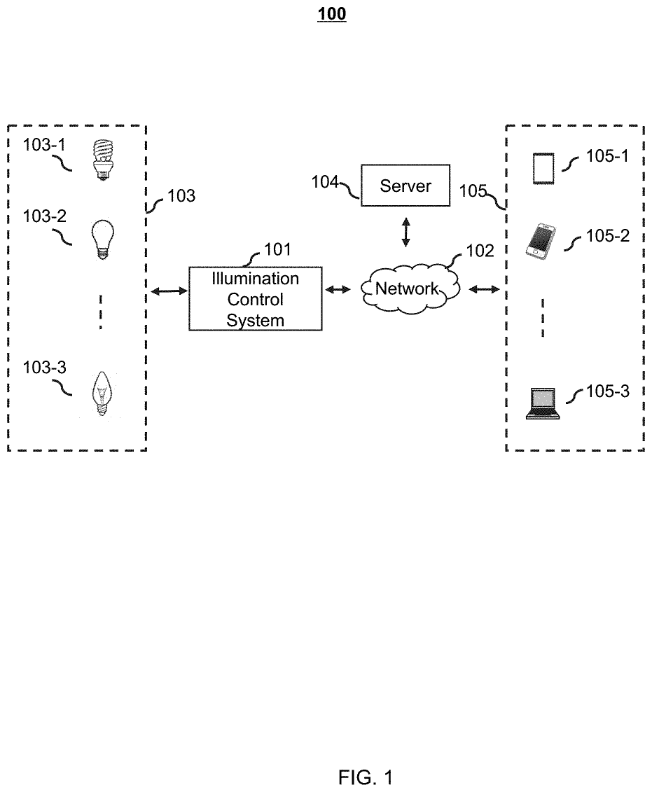

FIG. 1 is a schematic diagram illustrating an application scenario of an illumination control system 101 according to some embodiments of the present disclosure. An illumination system 100 may include the illumination control system 101, a network 102, an illumination device 103, a server 104, and a terminal device 105. The illumination control system 101 may connect to the illumination device 103 and may communicate with the server 104 and the terminal device 105 via the network 102. In some embodiments, the illumination control system 101 may determine a type (e.g., a dimmable illumination device and/or a non-dimmable illumination device) of the illumination device 103 which connects to the illumination control system 101. A brightness and a power of a dimmable illumination device, such as a light-emitting diode (LED) lamp and an incandescent lamp, may be adjusted by changing a voltage or a current across the dimmable illumination device. The brightness and the power of a non-dimmable illumination device, such as a compact fluorescent light (CFL), may be difficult to adjust by changing the voltage or the current across the illumination device. In some embodiments, the illumination control system 101 may upload a determination result regarding the type of the illumination device to the server 104 for storage via the network 102, and may also send the determination result regarding the type of the illumination device to various terminal devices 105. In some embodiments, the illumination control system 101 may collect surrounding environmental information, such as temperature, sound, color, humidity, odor, illumination intensity, object motion information, etc., and process the collected information for light adjustment operations of the illumination device 103, including turning on, turning off, adjusting the brightness, etc. In some embodiments, the illumination control system 101 may control the light adjustment operations of the illumination device 105 by one or more circuit components. The circuit components may include a dimmer. The dimmer may adjust the brightness of the illumination device by changing an input voltage of the illumination device 103. The dimmer may be a rheostat dimmer, a solid-state dimmer, an autotransformer dimmer, etc. In some embodiments, the illumination control system 101 may interact with a user to obtain an user input, and the user may set various light control modes, such as light control modes for different scenarios such as getting up, falling asleep, leaving, reading, etc.

The network 102 may provide a connection among the illumination control system 101, the server 104, and the terminal device 105. The network 102 may include a local area network, a wide area network, a public network, a private network, a wireless local area network, a virtual network, a metropolitan area network, a public switched telephone network, etc., or a combination thereof. For example, the network 102 may be a network that communicates using protocols such as wireless fidelity (WiFi), Bluetooth, ZigBee, etc. The network 102 may be one of a wired network, a wireless network, a combined wired and wireless network, etc. In some embodiments, the network 102 may include various network access points, such as a wired or wireless access point, a base station, a network switching point, etc. Through an access point, a data source may be connected to the network 102 and send information via the network 102.

The illumination device 103 may include one or more of an incandescent lamp, an LED lamp, a fluorescent lamp, a CFL, a halogen lamp, a halogen tungsten lamp, a gas discharge lamps, etc. The illumination device 103 may include a dimmable illumination device and a non-dimmable illumination device. In some embodiments, the dimmable illumination device may include an incandescent lamp, an LED lamp, or other illumination device, etc.; the non-dimmable illumination device may include a CFL lamp, etc.

The server 104 may process and/or store data related to the illumination system 100. The server 104 may be one or more of a file server, a database server, a WEB server, etc. In some embodiments, the server 104 may store data received or/and generated by the illumination control system 101, for example, a model, a lifetime, a usage parameter, etc. of the illumination device 103 connected to the illumination control system 101. In some embodiments, the server 104 may store some configuration settings of a user on the illumination control system 101, for example, some settings of the user on light control modes in different scenarios. In some embodiments, the server 104 may receive data collected by the illumination control system 101 and perform subsequent processing. For example, voltage or current data in the circuit collected by the illumination control system 101 may be uploaded to the server 104 via the network 102, and the server 104 may determine a type of illumination device 103 based on the data.

The terminal device 105 may communicate with the illumination control system 101 via the network 102. The terminal device 105 may include one or more of a mobile phone, a tablet computer, a laptop computer, a smart wearable device (e.g., a smartwatch, smart glasses, a head-mounted display, etc.), a video camera, etc. In some embodiments, the terminal device 105 may send a user input to the illumination control system 101 via the network 102, for example, the mobile phone as the terminal device 105 may transmit settings of light control modes in various scenarios, a command to turn on or off the light control modes in different scenarios, etc., to the illumination control system 101. In some embodiments, the terminal device 105 may receive various data sent by the illumination control system 101 via the network 102. For example, the mobile phone of the users, etc. may receive feedback information that the light control mode is set successfully, the type data of the illumination device 103, time reminder information, etc. In some embodiments, the terminal device 105 may collect data and transmit it to the illumination control system via the network 102. For example, the terminal device 105 may include one or more cameras, and the camera may collect surrounding video data and transmit it to the illumination control system 101.

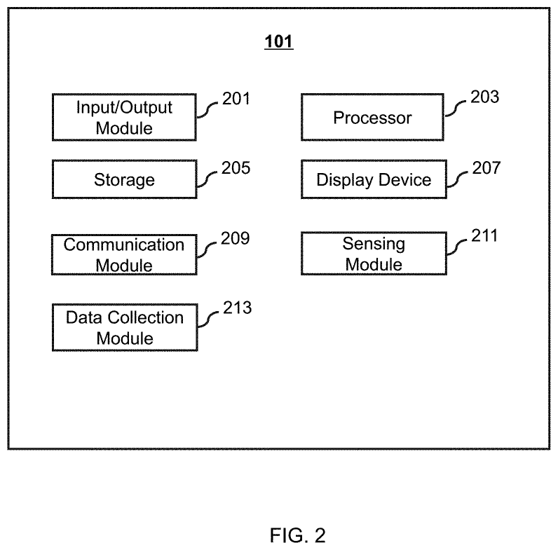

FIG. 2 is block schematic diagram of the illumination control system 101 according to some embodiments of the present disclosure. As shown in FIG. 2, the illumination control system 101 may include an input/output module 201, a processor 203, a storage 205, a display device 207, a communication module 209, a sensing module 211, and a data collection module 213. The connection among the various modules of the illumination control system 101 may be a wired connection, a wireless connection, or a combination of a wired connection and a wireless connection.

The input/output module 201 may obtain data and output data. In some embodiments, a user may input information data through the input/output module 201, and the input information may include one or more of a number, a text, an image, a sound, a video, etc. For example, the input information may include a light adjustment parameter, time information (a leaving time of the user, a time when the user gets home, a time period in the night), bio feature information (a face contour, an iris, a fingerprint, etc.), instructions (a voice, a gesture), etc. In some embodiments, the input/output module 201 may support various input operation modes, such as a handwriting operation, a touch screen operation, a button or key operation, a voice control operation, a gesture operation, a mouse operation, an eye contact operation, a voice operation, etc. In some embodiments, the input/output module 201 may transmit the input data to the processor 103 for processing. In some embodiments, the input/output module 201 may transmit the input data to the storage 205 for storage. In some embodiments, the input/output module 201 may transmit the input data to the display device 207 for display. In some embodiments, the input/output module 201 may transmit the input data to the communication module 209 and then to other devices or modules. In some embodiments, the illumination control system 101 may output some data to other devices, such as a USB device, a mobile hard disk, an optical disks, etc. through the input/output module 201. In some embodiments, the illumination control system 101 may also output voice information through a device such as a speaker. The voice information may be the information of the determination result regarding the type of the illumination device 103, which may be a sound prompting that a light control mode is turned on, a sound prompting that the user has successfully set a specific light control mode, etc.

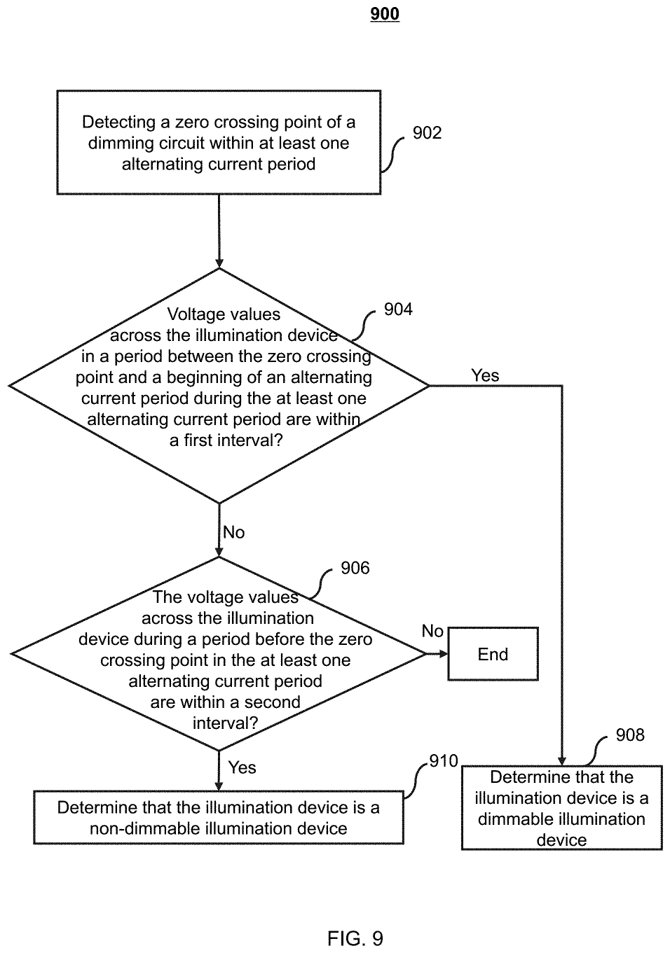

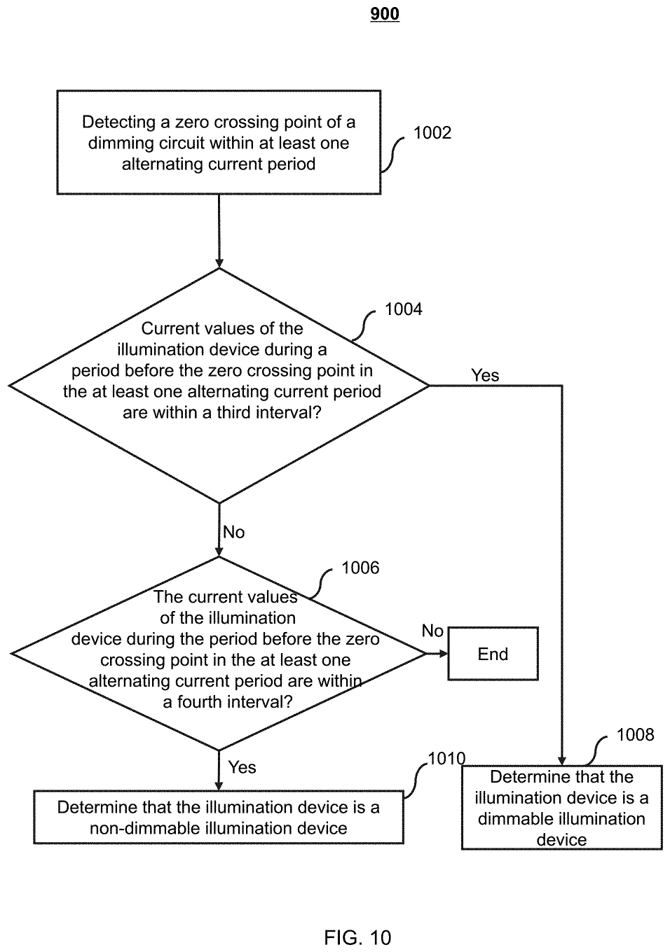

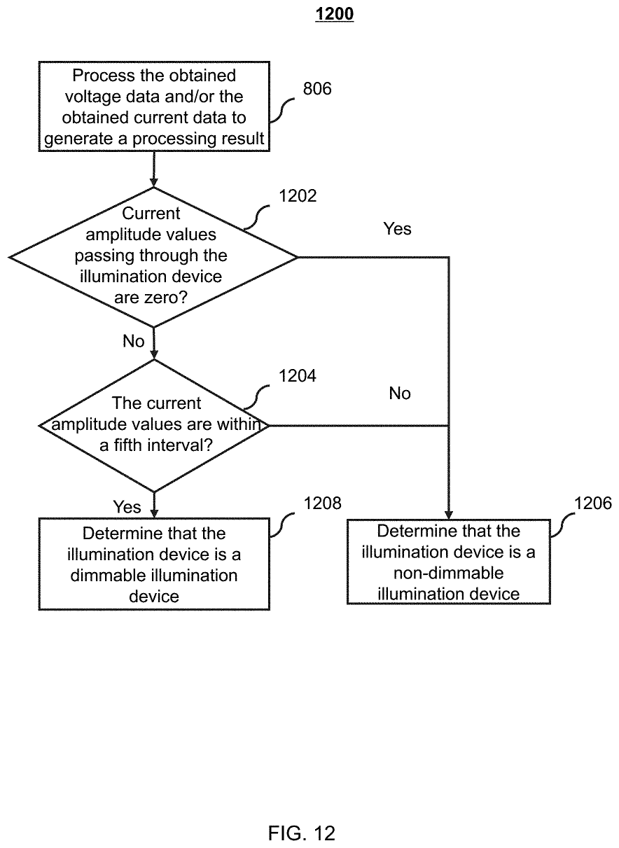

The processor 203 may provide data processing services for the illumination control system 101. The processor 203 may be a central processing unit (CPU), a digital signal processor (DSP), a system on chip (SoC), a microcontroller unit (MCU), etc. In some embodiments, the processor 203 may also be a specially designed processing element or device with a special function. The processor 203 may process data transmitted from the input/output module 201, the storage 205, the communication module 209, the data collection module 213, and the sensing module 211. In some embodiments, the processor 203 may process the obtained information by using one or more processing methods. The processing method may include a fitting, a normalization, an interpolation, a discretization, an integration, an analog-to-digital conversion, a Z-transform, a Fourier transform, a low-pass filtering, a histogram enhancement, an image feature extraction, etc. For example, the processor 203 may perform a Fourier transform on a microwave signal obtained by a microwave sensor and identify and exclude components with a fixed frequency in the microwave signal. In some embodiments, according to the data transmitted by the data collection module 203, the processor 203 may determine the type of the illumination device 103 connected to the illumination control system 101. In some embodiments, according to the processing result of the information, the processor 203 may make a determination and generate a control instruction. For example, the processor 203 may perform steps in one or more of FIG. 9, FIG. 10, or FIG. 12. In some embodiments, the processor 203 may transmit the processed data to the storage 205 for storage. In some embodiments, the processor 203 may transmit the processed data to the input/output module 201 for output. In some embodiments, the processor 203 may transmit the processed data to the display module 207 for display. In some embodiments, the processor 203 may also transmit the processed data to the communication module 201 and then to other devices or modules.

The storage 205 may store data obtained from and generated by the illumination control system 101. The information stored by the storage 205 may include the information input by the input/output module 201, the data processed by the processor 203, the information received by the communication module 209, the environmental information obtained by the sensing module 211, and the information collected by the data collection module 213. The information stored in storage 205 may be texts, voices, images, etc. In some embodiments, the storage 205 may include, but not limited to, various types of storage devices such as a solid-state drive, a mechanical hard drive, a universal serial bus (USB) device flash memory, a SD (secure digital) memory card, a compact disc, a random-access memory (RAM) and a read-only memory (ROM). In some embodiments, the storage 205 may be a storage device inside the illumination control system 101, a storage device external to the illumination control system 101, or a network storage device (e.g., a storage on a cloud storage server) outside the illumination control system 101.

The display device 207 may be used for displaying information. The display device 207 may be one or more of a cathode ray tube (CRT) display, a light-emitting diode display (LED), a liquid crystal display (LCD), an organic light-emitting diode (OLED) displays, a projection display, etc. In some embodiments, the display device 207 may display the user input information transmitted by the input/output module 201, such as a light control mode selected by the user, start time and end time of the mode, a voice instruction regarding the start of the mode, a finger instruction, or other information. In some embodiments, the display device 207 may display the data processed by the processor 203 in the form of texts, images, numbers, etc. For example, the determination result determined by the processor 203 regarding the type of the illumination device 103 which is connected to the illumination control system 101 may be displayed by the display device 207. In some embodiments, the display device 207 may also display the data transmitted by the data collection module 213 after preprocessing and the display form may include numbers, images, etc.

The communication module 209 may establish communication between the illumination control system 101 and other devices and communication among the modules of the illumination control system 101. The communication mode may include a wired communication mode and a wireless communication mode. The wired communication mode may include a communication through a wire, a cable, an optical cable, or other transmission media. The wireless communication mode may include any suitable communication modes such as IEEE 802.11 series wireless LAN communication, IEEE 802.15 series wireless communication (e.g., Bluetooth, ZigBee, etc.), mobile communication (a satellite communication, a microwave communication, an infrared communication, etc.), or a combination of the communication modes. In some embodiments, the communication module 209 may adopt one or more encoding methods to encode the transmission information. For example, the encoding methods may include a phase encoding, a non-return-to-zero encoding, a differential Manchester code, etc. In some embodiments, the communication module 209 may select different transmission and encoding methods according to a type of data to be transmitted or different types of networks. In some embodiments, the communication module 209 may include one or more communication interfaces for different communication modes. In some embodiments, other modules illustrated in the illumination control system 101 may be distributed on various devices. In this situation, each of the other modules may include one or more communication modules 209 to perform information transmission among the modules. In some embodiments, the communication module 209 may include a receiver and a transmitter. In another embodiment, the communication module 209 may be a transceiver.

The sensing module 211 may include one or more sensors. In some embodiments, the sensing module 211 may be or include a sound sensor, an image sensor, a temperature sensor, an infrared sensor, a humidity sensor, a light intensity sensor, a gas sensor, a microwave sensor, an ultrasonic sensor, or the like, or a combination thereof. The sensing module 211 may obtain environmental information, such as sound, temperature, humidity, illumination intensity, odor, information about a movement of an object, etc. The sensing module 211 may transmit the obtained environmental information to the processor 203 for subsequent processing and may store it in the storage 205. In some embodiments, the sensing module 211 may preprocess the obtained environmental information and then send it to the display device 207 for display. Alternatively, the sensing module 211 may preprocess the obtained environmental information and send it to the processor 203 for further processing.

The data collection module 213 may collect data during the illumination control system 101 is operating. In some embodiments, the illumination device 103 may be connected to the illumination control system 101 and a type of the illumination device 103 may be determined. The data collection module 213 may collect related data, such as voltage data and current data across the illumination device 103. The data collection module 213 may also monitor various parameters of the illumination control system 101, such as a status of each sensor, a used capacity of the storage, an available resource of the processor, etc. The data collected by the data collection module 213 may be transmitted to the storage 205 for storage, or may be transmitted to the processor 203 for further processing, or may be transmitted to the communication module 209 for further transmission to other devices or modules. In some embodiments, the data collection module 213 may preprocess the collected data and the preprocessed data may be transmitted to the display device 207 for display in number form or in image form.

It should be noted that the above description of each module in the illumination control system 101 is only some specific embodiments and should not be considered as the only feasible solution. Obviously, for persons have ordinary skill in the art, after understanding the basic principles of each module, various modifications and changes may be made to the module configuration of the illumination control system 101 without departing from this principle, but these modifications and changes are still within the scope described in the present disclosure. For example, in some embodiments, the illumination control system 101 may only include a part of all the modules shown in FIG. 2. In some other embodiments, two or more modules may be combined into one module, for example, the input module 201 and the display device 207 may be combined into one module, for example, in the form of a touch display screen, etc. In some other embodiments, a module may also be divided into two or more modules, for example, the processor 203 may be divided into sub-processors with different functions.

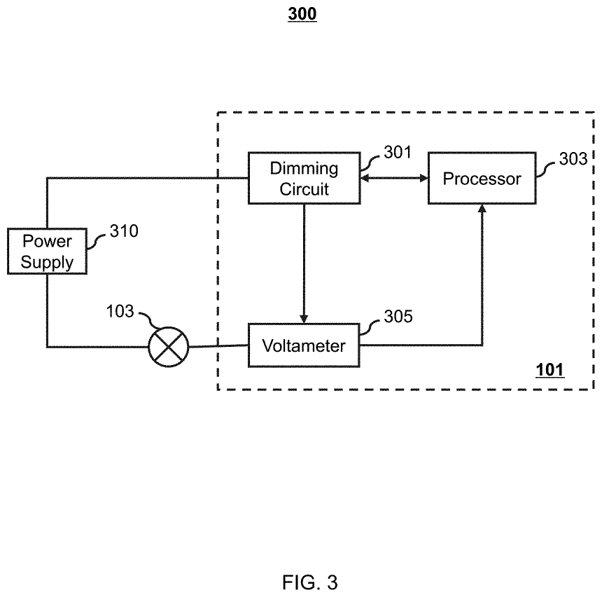

FIG. 3 is a schematic diagram illustrating an exemplary application circuit of the illumination control system 101 according to some embodiments of the present disclosure. As shown in FIG. 3, the circuit system 300 may include a power supply 310, the illumination device 103, and the illumination control system 101. The power supply 310 may provide alternating current power to the circuit, the power supply 310 may be a mains alternating current line, or may be a battery, a generator, etc. The illumination device 103 may include a CFL lamp, an incandescent lamp, a LED lamp, or other illumination device. The illumination control system 101 and the illumination device 103 may be connected to the power supply 310 to form a loop. When the power supply 310 is in a working state (power on or connected to the mains), the illumination control system 101 may determine the type of the illumination device 103 and may also perform light adjustment operations on the illumination device 103 based on the determination result.

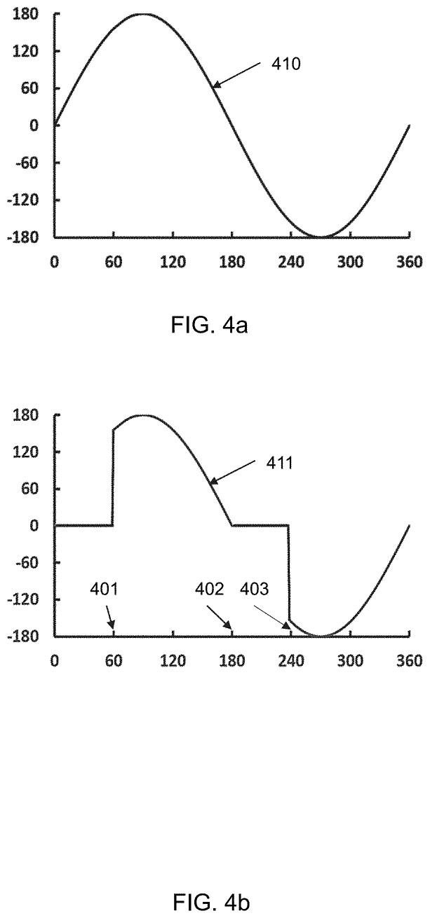

The illumination control system 101 may include a dimming circuit 301, a processor 303, and a voltameter 305. The dimming circuit 301 may include a part or all of the modules shown in FIG. 2 and may perform light adjustment operations on the illumination device 103. In some embodiments, the dimming circuit 301 may be a silicon controlled dimming circuit using phase control. The silicon controlled dimming circuit 301 using phase control may be controlled by leading-edge phase-cut or trailing-edge phase-cut. The dimming principle of a silicon controlled circuit controlled by leading-edge phase-cut is shown in FIG. 4, which will be described below. In some embodiments, the light adjustment operations performed by the dimming circuit 301 may include turning on and off the illumination device 103, adjusting the brightness of the illumination device 103, etc. In some embodiments, the dimming circuit 301 may perform the light adjustment operations based on a light control mode set by a user, for example, the user may preset a moment when the illumination device is turned on or off, a light brightness, an environmental illumination intensity, etc. In some embodiments, the dimming circuit 301 may also obtain related data of the surrounding environment by a sensor, process the data, and select an appropriate light control mode based on the processing result, and execute it. In some embodiments, when the power supply 310 is a mains input, the dimming circuit 310 may include one or more optical couplers (OC) for electrical isolation.

The voltameter 305 may measure related parameters of the circuit 300, such as voltage data across the illumination device 103 and current data in the circuit. In some embodiments, the voltameter 305 may be a programmable logic device (PLD), an application-specific integrated circuit (ASIC), a single chip microcomputer (SCM), a system on chip (SoC), etc. The voltameter 305 may transmit measured parameters to the processor 303. In some embodiments, the processor 303 and the voltameter 305 may be integrated into a certain component or circuit to implement the functions of both.

The processor 303 may further process the parameters measured by the voltameter 305 and make a decision based on the processing result to generate control instructions. In some embodiments, the voltameter 305 may measure and collect voltage data and current data across the illumination device 103 and transmit the data to the processor 303. The processor 303 may execute steps described in FIG. 9, FIG. 10, or FIG. 12, generate a determination result, and then generate corresponding control instructions and transmit it to the dimming circuit 301. The dimming circuit 301 may perform the dimming operation based on the instructions. In some other embodiments, the processor 303 may transmit the determination result to other modules (modules in shown in FIG. 2) of the illumination control system 101. For example, the processor 303 may transmit the determination result regarding the type of the illumination device 103 to the display device 207 for the result, or may also transmit it to the communication module 209 and then send it to other devices, such as a mobile device, a server, a cloud storage, etc.

In some embodiments, the circuit 300 may determine the type of the illumination device 103. The power supply 310 may be an alternating current power supply. The dimming circuit 301 may include the silicon controlled dimming circuit controlled by leading-edge phase-cut. The illumination device 103 may include one of a dimmable illumination device (e.g., an incandescent lamp, an LED lamp) or a non-dimmable illumination device (e.g., a CFL lamp). When the illumination device 103 is connected to the circuit system 300 and the power is turned on, the voltameter 305 may measure and collect voltage data and current data across the illumination device 103 in several alternating current periods and transmit the data to the processor 303. The processor 303 may determine the type of the illumination device 103 based on the voltage data and/or the current data and transmit the determination result to the dimming circuit 301. In some embodiments, the processor 303 may also generate control instructions based on the determination result regarding the type of the illumination device 103. The processor 303 may transmit the control instructions to the dimming circuit 303. The dimming circuit 303 may execute the instructions and perform corresponding operations.

FIG. 4a and FIG. 4b are schematic diagram illustrating waveforms of a leading-edge phase-cut dimming control according to some embodiments of the present disclosure. As shown in FIG. 4a and FIG. 4b, the horizontal axis represents a phase angle of the alternating current and the vertical axis represents a voltage value of the alternating current. In FIG. 4a, 410 represents a waveform curve of a normal alternating current voltage in an alternating current period. An alternating current period of 410 may be divided into a front half period and/or a first half period (e.g., a phase angle from 0° to) 180° and a latter half period and/or a second half period (e.g., a phase angle from 180° to) 360°. In FIG. 4b, 411 represents the waveform curve of the alternating current voltage after the leading-edge phase-cut in an alternating current period, wherein 401 represents that the phase angle of the alternating current is 60°, 402 represents that the phase angle of the alternating current is 180°, and 403 represents that the phase angle of the alternating current is 240°. Similarly, an alternating current period of 411 may be divided into a front half period and/or a first half period (e.g., a phase angle from 0° to 180°) and a latter half period and/or a second half period (e.g., a phase angle from 180° to 360°). In some embodiments, 410 may represent a waveform curve of a voltage in a non-dimmable circuit. For example, in a non-dimmable circuit, an alternating current voltage may be applied to the circuit starting from a voltage phase angle of 0°, and the voltage-phase curve (e.g., 410) of the alternating current voltage is a sine curve. In some embodiments, 411 may represent a voltage curve of a silicon controlled dimming circuit (e.g., the dimming circuit 301 in FIG. 3) after being performed a leading-edge phase-cut operation using leading-edge phase-cutting control. For example, in a silicon controlled dimming circuit controlled by leading-edge phase-cut, a voltage may be applied to the circuit starting from a voltage phase angle of 0°, and the silicon controlled may be turned on when the voltage phase angle is 60° (401 may be called a trigger angle). According to thyristor characteristics of the silicon controlled, the conduction of the silicon controlled will be maintained even after the trigger voltage is removed, and may be maintained until the end of the first half period of the sine wave. In summary, the silicon controlled may be in a non-conducting state during a phase angle range from 0° to the trigger angle. The phase angle from 0° to the trigger angle may be marked as a down period of the silicon controlled. The silicon controlled may be in a conducting state during a phase angle range from the trigger angle to 180°. The phase angle range from the trigger angle to 180° may be marked as a conduction period of the silicon controlled. The conduction of the silicon controlled may control the conduction of the circuit. When the silicon controlled is turned on, an illumination device in the circuit may be turned on; when the silicon controlled is turned off, the illumination device in the circuit may be turned off. Comparing FIG. 4a and FIG. 4b, it may be seen that the trigger angle 401 of 60° cuts off a part of the original full front half period (i.e., a phase angle range from 0° to 180° in 410) of the alternating current and makes the second half conductive, so that the front half period of 410 becomes the front half period of 411. In some embodiments, when the dimming circuit uses a bidirectional silicon controlled, the applied alternating current may be reversed at a phase angle of 180° and the bidirectional silicon controlled may be conductive until the phase angle is 240°, and the conduction may be maintained until the end of the second half period of the 411. That is, an alternating current may be applied to a bidirectional silicon controlled dimming circuit to control the dimming circuit to be turned on or turned off during the front half period and the latter half period.

In FIG. 4b, when the trigger angles of the conductive silicon controlled are different, the voltage effective values of the silicon controlled circuit may be different during the silicon controlled conduction period, so that the voltage effective values of the voltage across the illumination device in this dimming circuit are also different. Therefore, the brightness of the illumination device is correspondingly different and the voltage values across the illumination device may be controlled by selecting different trigger angles to achieve the dimming operations of the illumination device. According to the silicon controlled dimming method, the illumination is adjusted by adjusting voltages. In some embodiments, different illumination devices may not support this kind of dimming method due to different illumination principles and circuit structures. For example, an illumination device, such as an LED lamp or an incandescent lamp, may support the silicon controlled dimming method using phase control, while an illumination device, such as a CFL lamp, may not support the silicon controlled dimming method using phase control. When different types of illumination devices are connected to a silicon controlled dimming circuit (e.g., as shown in FIG. 3), the waveforms and phases of the current and voltage may show different features. In some embodiments, circuit using the silicon controlled dimming method may be used to determine the type of the illumination device based on different features of the voltage presented by different illumination devices at a preset voltage.

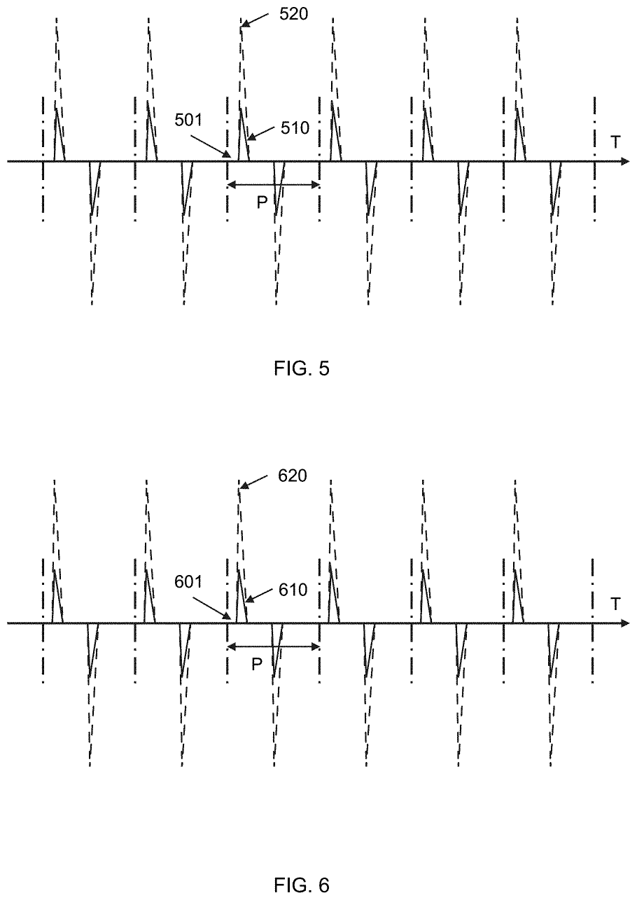

FIG. 5 is a schematic diagram illustrating an exemplary amplitude-phase of voltage-current of a dimmable illumination device according to some embodiments of the present disclosure. The horizontal axis T represents time. A curve 510 is an amplitude-phase curve of a voltage of the dimmable illumination device (e.g., an incandescent lamp). A curve 520 is an amplitude-phase curve of a current of the dimmable illumination device (e.g., an incandescent lamp). A point 501 is a zero crossing point of the current. In the present disclosure, the zero crossing point may correspond to a position where a sign of a signal (the current, the voltage, or other physical quantity) changes (e.g., from a positive sign to a negative sign, from a negative sign to a positive sign, etc.). In some embodiments, the zero crossing point may correspond to a moment, such as a moment when a sign of a signal changes. Both the curve 510 and the curve 520 may include 6 alternating current periods P shown in FIG. 5. In some embodiments, the dimmable illumination device (e.g., the incandescent lamp) may be connected to a silicon controlled dimming circuit using phase control (e.g., the circuit shown in FIG. 3), wherein the voltameter 305 may monitor voltage data of the dimmable illumination device (e.g., the incandescent lamp) and current data in the circuit. When the dimming circuit 301 is turned on, the exemplary curves of the voltage data and the current data monitored by the voltameter 305 are 510 and 520. The curve 510 and the curve 520 show obvious periodicity. Take a period P where the zero crossing point 501 is located as an example, during a period between the zero crossing point 501 and the beginning of the period P (hereinafter referred to as a “period before the zero crossing point”) and a period between the zero crossing point 501 and the end of the period P (hereinafter referred to as a “period after the zero crossing point”), the voltage-current values of the dimmable illumination device (e.g., the incandescent lamp) are significantly different. The voltage-current values during the period before the zero crossing point 501 are close to zero and the voltage-current values during the period after the zero crossing point 501 have obvious waveform changes.

FIG. 6 is a schematic diagram illustrating an exemplary amplitude-phase of voltage-current of a dimmable illumination device according to some embodiments of the present disclosure. The horizontal axis T represents time. A curve 610 is an amplitude-phase curve of a voltage of the dimmable illumination device (e.g., an LED lamp). A curve 620 is an amplitude-phase curve of a current of the dimmable illumination device (e.g., the LED lamp). A point 601 is a zero crossing point of the current. Both the curve 610 and the curve 620 include 6 alternating current periods P shown in FIG. 6. In some embodiments, the dimmable illumination device (e.g., the LED lamp) may be connected to a silicon controlled dimming circuit using phase control (e.g., the circuit shown in FIG. 3). The voltameter 305 may monitor voltage data of the dimmable illumination device (e.g., the LED lamp) and current data in the circuit. When the dimming circuit is turned on, the exemplary curves of the voltage data and the current data monitored by the voltameter 305 are 610 and 620. The curve 610 and the curve 620 show obvious periodicity. Take a period P where the zero crossing point 601 is located as an example, during a period before the zero crossing point and a period after the zero crossing point, the voltage-current values of the dimmable illumination device (e.g., the LED lamp) are significantly different. The voltage-current values in the period before the zero crossing point 601 are close to zero and the voltage-current values in the period after the zero crossing point 601 have obvious waveform changes.

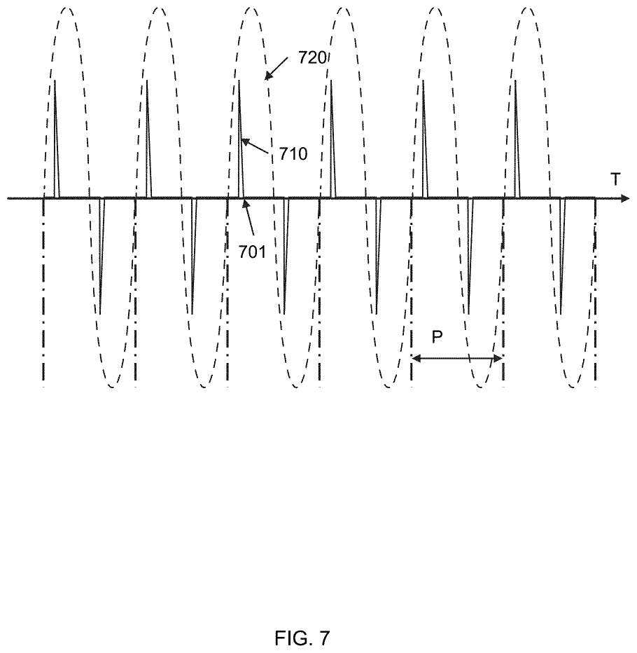

FIG. 7 is a schematic diagram illustrating an exemplary amplitude-phase of voltage-current of a non-dimmable illumination device according to some embodiments of the present disclosure. The horizontal axis T represents time. A curve 710 is an amplitude-phase curve of a voltage of a non-dimmable illumination device (e.g., a CFL lamp). A curve 720 is an amplitude-phase curve of a current of the non-dimmable illumination device (e.g., the FL lamp). A point 701 is a zero crossing point of the current. Both the curve 710 and the curve 720 include 5 alternating current periods P shown in FIG. 7. In some embodiments, the non-dimmable illumination device (e.g., the CFL lamp) may be connected to a silicon controlled dimming circuit using phase control (e.g., the circuit shown in FIG. 3). The voltameter 305 may monitor voltage data of the CFL lamp and current data in the circuit. When the dimming circuit is turned on, the data curves monitored by the voltameter 305 are 710 and 720. The curve 710 and the curve 720 show obvious periodicity. Take a period P where the zero crossing point 701 is located as an example, voltage values during a period before the zero crossing point 701 are significantly different from the voltage values of the dimmable illumination devices in FIG. 5 and FIG. 6 during the periods before the respective zero crossing points.

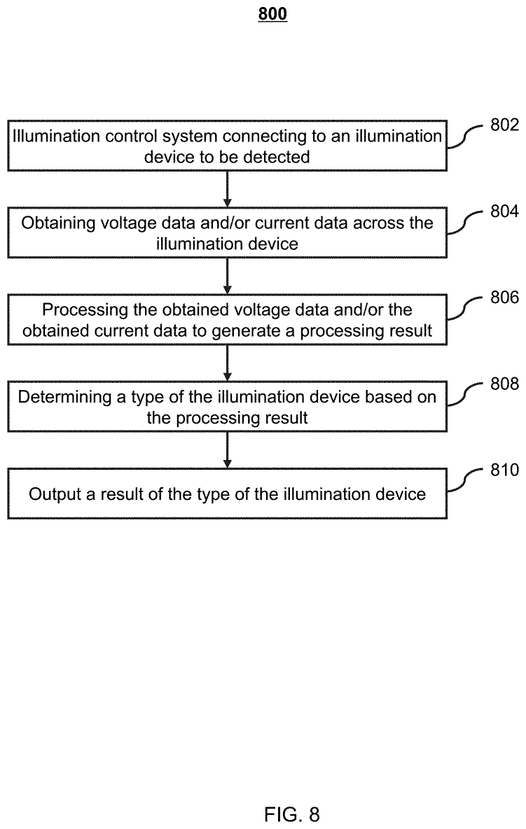

A dimmable illumination device (e.g., an incandescent lamp, a LED lamp) may be an illumination device that is dimmable according to silicon controlled circuits using phase control. A non-dimmable illumination device (e.g., a CFL lamp) may be an illumination device that is not dimmable according to silicon controlled circuits using phase control. In some embodiments of the present disclosure, the type of the illumination device may be detected according to features of the amplitude-phase of the voltage-current exhibited by different types of illumination devices when the illumination devices are connected to a silicon controlled circuit using phase control. For example, FIG. 8-FIG. 10 are flowcharts illustrating methods for detecting an illumination device according to some embodiments of the present disclosure.

FIG. 8 is a flowchart illustrating an exemplary method 800 for determining a type of an illumination device according to some embodiments of the present disclosure. In some embodiments, the method 800 may be performed by the illumination control system 101.

In step 802, the illumination control system 101 may connect to the illumination device to be detected. In some embodiments, the illumination device to be detected may be connected to the illumination control system 101 through a circuit connection mode shown in FIG. 3. The illumination control system 101 may include a silicon controlled dimming circuit using phase control and may further include a bidirectional silicon controlled dimming circuit controlled by leading-edge phase-cut.

In step 804, the voltameter 305 may obtain voltage data and/or current data across the illumination device to be detected. In some embodiments, the illumination control system 101 may adopt the circuit connection shown in FIG. 3, in which the voltameter 305 may measure and collect voltage data across the illumination device and current data in the circuit. In some embodiments, the voltameter 305 may collect voltage data and current data of the illumination device in several adjacent alternating current periods. There may be two, three, or more adjacent alternating current periods.

In step 806, the processor 303 may process the obtained voltage data and/or the obtained current data to generate a processing result. In some embodiments, the illumination control system 101 shown in FIG. 3 may be adopted, wherein the processor 303 may process the collected voltage data and/or the current data. Processing methods may include a fitting, a normalization, an interpolation, a discretization, an integration, an analog-to-digital conversion, a Z-transform, a Fourier transform, a low-pass filtering, a histogram enhancement, an image feature extraction, or the like, or a combination thereof.

In step 808, the processor 303 may determine a type of the illumination device based on the processing result. In some embodiments, the type of the illumination device may include a dimmable illumination device, a non-dimmable illumination device, etc. In some embodiments, it may follow the exemplary steps shown in FIG. 9 and FIG. 10 to determine the type of the illumination device, which will be described in detail below.

In step 810, the processor 303 may output a result of the type of the illumination device. In some embodiments, the processor 303 may send the result of the type of the illumination device to other devices, such as a mobile phone, a computer, a tablet computer, etc., via a network. In some embodiments, the processor 303 may output the result of the type of the illumination device to a display device, such as an LED display, to display the result of the type of the illumination device. The processor 303 may also play the type of the illumination device through a sound output device such as a speaker.

In some embodiments, the method 800 may be performed sequentially. In some other embodiments, the method 800 may not be performed sequentially. For example, after step 808 is performed, when the processed voltage and/or current data are insufficient to determine the type of the illumination device, the illumination control system 101 may perform step 804 and step 806 again to collect and process more data to support step 808.

FIG. 9 is a flowchart illustrating an exemplary method 900 for determining a type of an illumination device according to some embodiments of the present disclosure. In some embodiments, the illumination control system 101 may include a bidirectional silicon controlled dimming circuit using phase control, and the method 900 may be a flowchart for determining the type of the illumination device implemented by the illumination control system 101. In some embodiments, the method 900 may be performed by a processor, such as a processor 303 in FIG. 3.

In step 902, a zero crossing point of a dimming circuit within at least one alternating current period is detected. The detection of the zero crossing point may be completed by a zero crossing point detection circuit. In some embodiments, the zero crossing point detection circuit may include a hardware zero crossing comparator, a microprocessor, an optical coupler, etc. In some embodiments, the zero crossing point detection circuit may be integrated into the dimming circuit (e.g., the dimming circuit 301 in FIG. 3) to implement its function.

In step 904, the processor 303 may determine whether voltage values across the illumination device in a period between the zero crossing point and a beginning of an alternating current period (may be referred to as a period before the zero crossing point) during the at least one alternating current period are within a first interval. In some embodiments, the first interval may be an interval between zero and a first threshold, wherein the first threshold may be a maximum value of a voltage burr (a voltage jump) in the dimming circuit. The first interval may or may not include endpoint values. The first interval may be used to characterize a voltage range of the silicon controlled in the dimming circuit in a non-conducting state. In some embodiments, the first threshold may be determined based on different silicon controlled models or parameters of other components in the dimming circuit. Different silicon controlled models and/or different component parameters may correspond to the same or different first thresholds. If the processor 303 determines that the voltage values across the illumination device are not in the first interval during the period before the zero crossing point, the process 900 may proceed to step 906 to determine whether the voltage values across the illumination device are in a second interval during a period before the zero crossing point. If the processor 303 determines that the voltage values across the illumination device are in the first interval during the period before the zero crossing point, the process 900 may proceed to step 908 to determine that the illumination device is a dimmable illumination device. In some embodiments, the dimmable illumination device may include a LED lamp and an incandescent lamp.

In step 906, the processor 303 may determine whether the voltage values across the illumination device during the period before the zero crossing point in the at least one alternating current period are in the second interval. In some embodiments, the second interval may include one or more voltage values greater than the first threshold. The second interval may be used to characterize a voltage range of the silicon controlled in the dimming circuit in a conducting state. If the processor 303 determines that the voltage values across the illumination device are in the second interval during the period before the zero crossing point, the process 900 may proceed to step 910 to determine that the illumination device is a non-dimmable illumination device. In some embodiments, the non-dimmable illumination device may include a CFL lamp. If the processor 303 determines that the voltage values across the illumination device during the period before the zero crossing point are not in the second interval, the process 900 may end.

FIG. 10 is a flowchart illustrating an exemplary method 1000 for determining a type of an illumination device according to the present disclosure. In some embodiments, the illumination control system 101 may include a silicon controlled dimming circuit using phase control. The method 1000 may be a flowchart for determining the type of the illumination device implemented by the illumination control system 101. In some embodiments, the method 1000 may be performed by a processor, such as a processor 303 in FIG. 3.

In step 1002, the zero crossing point of the dimming circuit in at least one alternating current period is detected. The detection of the zero crossing point may be completed by a zero crossing point detection circuit. In some embodiments, the zero crossing detection circuit may include a hardware zero crossing comparator, a micro-processor, an optical coupler, etc. In some embodiments, the zero crossing detection circuit may be integrated into a dimming circuit (e.g., the dimming circuit 301 in FIG. 3) to implement its function.

In step 1004, the processor 303 may determine whether current values of illumination device during a period before the zero crossing point in the at least one alternating current period are within a third interval. In some embodiments, the third interval may be an interval between zero and a second threshold, wherein the second threshold is a maximum value of a current burr in the dimming circuit. The third interval may or may not include endpoint values. The third interval may be used to characterize a current range of the silicon controlled in the dimming circuit in a non-conducting state. In some embodiments, the second threshold may be determined based on silicon controlled models or the other components of the circuit in the dimming circuit. Different silicon controlled models and/or different component parameters may correspond to the same or different second thresholds. If the processor 303 determines that the current values of the illumination device during the period before the zero crossing point is not in the third interval, the process 1000 may proceed to step 1006 to determine whether the current values of the illumination device during the period before the zero crossing point are within a fourth interval. If the processor 303 determines that the current values of the illumination device during the period before the zero crossing point are within the fourth interval, the process 1000 may proceed to step 1008 to determine that illumination device is a dimmable illumination device. In some embodiments, the dimmable illumination device may include a LED lamp, and an incandescent lamp.

In step 1006, the processor 303 may determine whether the current values of the illumination device are within the fourth interval during the period before the zero crossing point in the at least one alternating current period. In some embodiments, the fourth interval may include one or more current values greater than the second threshold. The fourth interval may be used to characterize a current values range of the silicon controlled in the dimming circuit in the conducting state. The fourth interval may or may not include endpoint values. If the processor 303 determines that the current values of the illumination device are in the fourth interval during the period before the zero crossing point, the process 1000 may proceed to step 1010 to determine that the illumination device is a non-dimmable illumination device. In some embodiments, the non-dimmable illumination device may include a CFL lamp. If the processor 303 determines that the current values of the illumination device during the period before the zero crossing point is not in the fourth interval, the process 1000 may end.

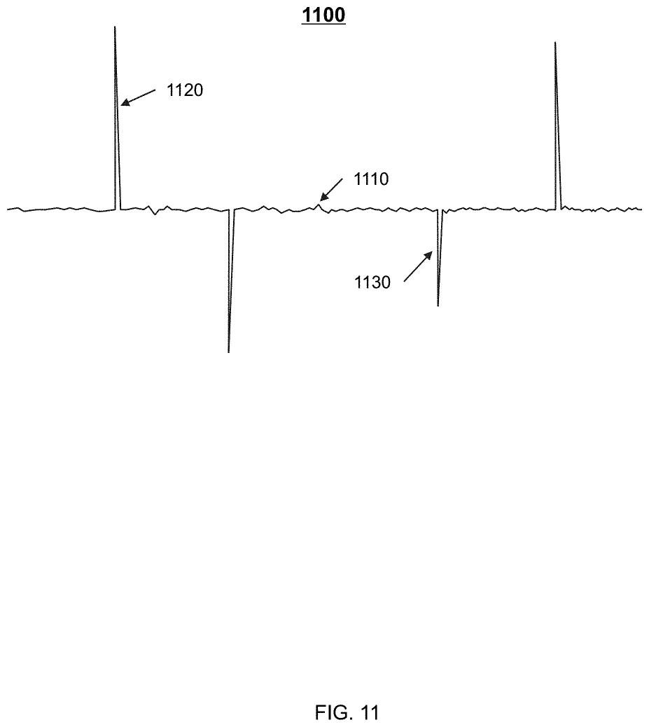

FIG. 11 is a schematic diagram illustrating an exemplary current waveform of an illumination device according to some embodiments of the present disclosure. In some embodiments, the illumination control system 101 may adopt a silicon controlled dimming circuit using phase control. When some non-dimmable illumination devices are connected to the dimming circuit, the lights may flash, and the reason for the flashing is the phenomenon of losing current pulses. When this phenomenon occurs, the current waveform in the circuit may be the waveform 1100 shown in FIG. 11. In several alternating current periods, the normal current value distribution is shown as 1120 or 1130, and the current values have sharp peaks. However, the current values of 1110 are in a relatively small range. A small current value may be due to losing current pulses. Because it is difficult to drive the illumination device with a small current value, the illumination device is temporarily unable to emit light and then flashing occurs. In some embodiments, the type of the illumination device may be determined based on this feature.

FIG. 12 is a flowchart illustrating an exemplary method 1200 for determining a type of an illumination device according to some embodiments of the present disclosure. In some embodiments, method 1200 may be included in step 808 in method 800. After the obtained current data is processed and a processing result is generated in step 806, method 1200 may be executed. In some embodiments, method 1200 may be performed by a processor, such as a processor 303 in FIG. 3.

In step 1202, the processor 303 may determine whether current amplitude values passing through the illumination device are zero. If the current amplitude values are zero, the process 1200 may proceed to step 1206 to determine that the illumination device is a non-dimmable illumination device. If the current amplitude values through the illumination device are not zero, the process 1200 may proceed to step 1204 to further determine whether the current amplitude values are within a fifth interval.

In step 1204, the processor 303 may determine whether the current amplitude values passing through illumination device are within the fifth interval. In some embodiments, the fifth interval may be an interval between zero and a third threshold, wherein the third threshold may be a maximum value of a normal current pulse in the dimming circuit. The fifth interval may or may not include endpoint values. If the processor 303 determines that the current amplitude values passing through the illumination device are within the fifth interval, the process 1200 may proceed to step 1208 to determine that the illumination device is a dimmable illumination device. If the processor 303 determines that the current amplitude values passing through illumination device are not within the fifth interval, the process 1200 may proceed to step 1206 to determine that the illumination device is a non-dimmable illumination device.

The foregoing is a description of some embodiments of the present disclosure. Obviously, to those skilled in the art, the disclosure is merely an example and does not constitute a limitation on the present disclosure. Although it is not explicitly described here, those skilled in the art may make various modifications, improvements, and amendments to the present disclosure. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and/or “some embodiments” mean that a particular feature, structure or characteristic described in connection with the embodiment is included in at least one embodiment of the present disclosure. Therefore, it is emphasized and should be appreciated that two or more references to “an embodiment” or “one embodiment” or “an alternative embodiment” in various parts of this specification are not necessarily all referring to the same embodiment. In addition, some features, structures, or features in the present disclosure of one or more embodiments may be appropriately combined.

In addition, those skilled in the art may understand that aspects of the present disclosure may be illustrated and described through a number of patentable categories or situations, including any new and useful process, machine, product or substance combination, or any new and useful improvements to them. Accordingly, all aspects of the present disclosure may be performed entirely by hardware, may be performed entirely by software (including firmware, resident software, microcode, etc.), or may be performed by a combination of hardware and software. The above hardware or software may be called “data block”, “module”, “engine”, “unit”, “component” or “system”. In addition, aspects of the present disclosure may appear as a computer product located in one or more computer-readable media, the product including computer-readable program code.

Computer program code for carrying out operations for aspects of the present disclosure may be written in any combination of one or more programming languages, including an object oriented programming language such as Java, Scala, Smalltalk, Eiffel, JADE, Emerald, C++, C #, VB. NET, Python, etc., conventional procedural programming languages, such as the “C” programming language, Visual Basic, Fortran 2003, Perl, COBOL 2002, PHP, ABAP, dynamic programming languages such as Python, Ruby, and Groovy, or other programming languages. The program code may execute entirely on the user's computer, partly on the user's computer, as a stand-alone software package, partly on the user's computer and partly on a remote computer or entirely on the remote computer or server. In the latter case, the remote computer may be connected to the user's computer through any network form, such as a local area network (LAN) or wide area network (WAN), or connected to an external computer (e.g., via the Internet), or in a cloud computing environment, or as a service using software as a service (SaaS).

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various components described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. However, this disclosure method does not mean that the present disclosure object requires more features than the features mentioned in the claims. Rather, claim subject matter lies in less than all features of a single foregoing disclosed embodiment.

In some embodiments, the numbers expressing quantities of ingredients, properties, and so forth, used to describe and claim certain embodiments of the application are to be understood as being modified in some instances by the term “about,” “approximate,” or “substantially”. Unless otherwise stated, “about,” “approximate,” or “substantially” may indicate ±20% variation of the value it describes. Accordingly, in some embodiments, the numerical parameters set forth in the description and attached claims are approximations that may vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the application are approximations, the numerical values set forth in the specific examples are reported as precisely as practicable.

Each patent, patent application, patent application publication and other materials cited herein, such as articles, books, instructions, publications, documents, articles, etc., are hereby incorporated by reference in their entirety. Application history documents that are inconsistent or conflicting with the contents of the present application are excluded, and documents (currently or later attached to the present application) that limit the widest range of the scope of the present application are also excluded. It is to be noted that if the description, definition, and/or terminology used in the appended application of the present application is inconsistent or conflicting with the contents described in this application, the description, definition and/or terminology may be subject to the present application.

At last, it should be understood that the embodiments described in the present application are merely illustrative of the principles of the embodiments of the present application. Other modifications that may be employed may be within the scope of the application. Thus, by way of example, but not of limitation, alternative configurations of the embodiments of the application may be utilized in accordance with the teachings herein. Accordingly, embodiments of the present application are not limited to the embodiments that are expressly introduced and described herein.

1. A system, comprising:
a dimming circuit applied with an alternating current voltage; and
a processor configured to:
obtain related data of an illumination device connected to the dimming circuit within at least one alternating current period;
generate a processing result by processing the related data; and
determine a type of the illumination device based on the processing result.

2. The system of claim 1, wherein the dimming circuit includes a silicon controlled dimming circuit using phase control.

3. The system of claim 1, wherein the related data of the illumination device within the at least one alternating current period includes at least one of voltage data or current data.

4. The system of claim 2, wherein the related data of the illumination device within the at least one alternating current period includes voltage values across the illumination device during a period before a zero crossing point of the dimming circuit in an alternating current period.

5. The system of claim 4, wherein the processor is further configured to:
determine whether the voltage values across the illumination device are within a first interval; and
in response to a determination that the voltage values are within the first interval, determine that the illumination device is a dimmable illumination device.

6. The system of claim 4, wherein the processor is further configured to:
determine whether the voltage values across the illumination device are within a second interval; and
in response to a determination that the voltage values are within the second interval, determine that the illumination device is a non-dimmable illumination device.

7. The system of claim 2, wherein the related data of the illumination device within the at least one alternating current period includes current values of the illumination device during a period before a zero crossing point of the dimming circuit in an alternating current period.

8. The system of claim 7, wherein the processor is further configured to:
determine whether the current values of the illumination device are within a third interval; and
in response to a determination that the voltage values are within the third interval, determine that the illumination device is a dimmable illumination device.

9. The system of claim 7, wherein the processor is further configured to:
determine whether the current values of the illumination device are within a fourth interval; and
in response to a determination that the voltage values are within the fourth interval, determine that the illumination device is a non-dimmable illumination device.

10. The system of claim 2, wherein the related data of the illumination device within the at least one alternating current period includes current amplitude values in at least two adjacent alternating current periods.

11. The system of claim 10, wherein the processor is further configured to:
determine whether the current amplitude values of the illumination device are zero; and
in response to a determination that the current amplitude values are zero, determine that the illumination device is a non-dimmable illumination device.

12. The system of claim 10, wherein the processor is further configured to:
determine whether the current amplitude values of the illumination device are within a fifth interval; and
in response to a determination that the current amplitude values are within the fifth interval, determine that the illumination device is a dimmable illumination device.

13. The system of claim 1, wherein the type of the illumination device includes at least one of a dimmable illumination device or a non-dimmable illumination device.

14. A method, comprising:
providing a dimming circuit applied with an alternating current voltage and an illumination device connected to the dimming circuit;
obtaining related data of the illumination device within at least one alternating current period;
generating a processing result by processing the related data; and
determining a type of the illumination device based on the processing result.

15. The method of claim 14, wherein the dimming circuit includes a silicon controlled dimming circuit using phase control.

16. The method of claim 14, wherein the related data of the illumination device within the at least one alternating current period includes at least one of voltage data and current data.

17. The method of claim 15, wherein the related data of the illumination device within the at least one alternating current period includes voltage values across the illumination device during a period before a zero crossing point of the dimming circuit in an alternating current period.

18. The method of claim 17, further including:
determining whether the voltage values across the illumination device are within a first interval; and
in response to a determination that the voltage values are within the first interval, determining that the illumination device is a dimmable illumination device.

19. The method of claim 17, further including:
determining whether the voltage values across the illumination device are within a second interval; and
in response to a determination that the voltage values are in the second interval, determining that the illumination device is a non-dimmable illumination device.

20. The method of claim 15, wherein the related data of illumination device within the at least one alternating period includes current values of the illumination device during a period before a zero crossing point of the dimming circuit in an alternating current period.

21-26. (canceled)
